(19) United States
(12) Patent Application Publication
(10) Pub. No.: US 2016/0231877 A1
(43) Pub. Date: Aug. 11, 2016

(54) ANALYTICAL SEARCHES AND THEIR SMART USE IN ACCOUNT AND CONTACT MANAGEMENT

(71) Applicant: SAP SE, Walldorf (DE)

(72) Inventors: Jan Matthes, Darmstadt (DE); Marcin Tamberg, Dielheim (DE); Jutta Weber, Mannheim (DE); Stefanie Huber, Berlin (DE)

(21) Appl. No.: 14/618,375

(22) Filed: Feb. 10, 2015

(51) Int. Cl. G06F 3/0482; G06Q 10/06; G06F 3/0484

(52) U.S. Cl. CPC G06F 3/0482; G06F 3/0484; G06Q 10/06311

(57) ABSTRACT

A system and method for navigating a customer management application hosted on an electronic device that displays, by a processor, a plurality of customers and associated entries for each respective customer, analyzes the plurality of customers to determine one or more tasks associated with the plurality of customers, displays, by the processor, the associated tasks, and upon detecting a user input, varies the plurality of customers and the associated tasks according to the user input, wherein the associated entries include aggregated data originating from a plurality of backend data sources.

### FIELD OF INVENTION

The present invention generally relates to electronic customer management applications, and more particularly, relates to customer management applications that facilitate contact management.

### BACKGROUND

In today's hyper information age, it is not uncommon to manage large amounts of electronically stored information. A variety of applications and application types have been developed to enable users to view, query, manipulate, and delete data stored at backend systems. For example, many existing applications have been developed to manage particular data objects and/or object types.

Advances in computing technologies have enabled smaller devices, such as mobile phones and tablets, to execute more sophisticated functions and applications. As a result, people often utilize their mobile phones and tablets to perform many of the functions that they previously performed on their personal computers and laptops. For example, users now view websites, e-mail, and calendars on mobile devices.

A drawback of smaller devices is their reduced display size. In order to maximize the display size of these smaller devices, touchscreen interfaces are often used. The use of a touchscreen eliminates the need for a separate keypad such that additional space can be dedicated to a display. In addition, the use of touchscreens eliminates the need for a pointer object (e.g., arrow or cursor) within the display. Although touchscreens help to maximize display size on mobile phones and tablets, their small displays still present challenges to application developers.

Despite the decreasing size of electronic devices, existing applications and corresponding user interfaces continue to include increasing amounts of information. In addition, increased processing power has allowed application developers to implement more complex functions. For example, a sales representative may desire to quickly identify customers or potential customers to visit or follow-up with. Although the sales representative may utilize various criteria to identify such customers, the underlying information may be difficult to retrieve from a backend system. For example, current systems do not enable the combination of master data and transactional data because backend and overall system performance are greatly reduced.

Although an end user may desire to perform a specific task, such as review a client relationship, conventional static user-interfaces may require a user to review data from a plurality of applications and data sources. As a result, it may be difficult to quickly gather relevant customer information. Accordingly, there is a need to provide dynamic user interfaces that enable a user to quickly obtain an overview of customer information.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a system diagram depicting an architectural overview of a networked system for generating analytical searches according to an example embodiment.

FIG. 2 illustrates a representative view of an electronic device having a customer management application according to an example embodiment of the present invention.

FIG. 3 illustrates a representative view of an electronic device having a customer management application according to another example embodiment of the present invention.

FIG. 4 illustrates a method for navigating the customer management application according to an example embodiment of the present invention.

FIG. 5 illustrates a representative architecture of an electronic device according to an example embodiment of the present invention.

### DETAILED DESCRIPTION

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, and circuits have not been described in detail so as not to unnecessarily obscure aspects of the embodiments. Wherever possible, like reference numbers will be used for like elements.

A system and method for navigating a customer management application hosted on an electronic device is provided. Using the customer management application, a user may review data from a plurality of applications and data sources. Some example data sources include transactional information such as sales activities, quotations, and sales orders from customer resource management (CRM) and enterprise resource planning (ERP) systems. In addition, the data may be arranged within one or more account management displays. Thus, data originating from multiple data sources may be arranged on a single display.

User interfaces and associated methods for using an electronic device are described. The user interface may include a touchscreen, a gyroscopic, other acceleration device, keyboard, mouse, and/or other input/output devices. For example, finger gestures on a touchscreen a portable electronic device may be detected and may be used to navigate a customer management application. In some embodiments, the device is a portable electronic or communications device (e.g., a mobile phone or tablet). However, the electronic device is not limited to portable devices, but rather may also comprise stationary devices, such as a desktop computer. It should be understood that the user interfaces and associated methods may be applied to a variety of electronic devices, such as personal computers, laptops, and televisions, which may include one or more other physical user-interface devices, such as a keyboard, mouse, and/or touchscreen.

The electronic device may support a variety of applications, such as telephone, text messenger, and information management applications. The various applications that may be executed on the device may use at least one common physical user-interface device, such as a touchscreen. One or more functions of the user interface(s) as well as corresponding information displayed on the device may be adjusted and/or varied from one application to another and/or within a respective application. In this way, a common physical architecture of the device may support a variety of applications with user interfaces that are intuitive and transparent. In the discussion that follows, a customer management application is used as an example embodiment, but it should be understood that the user interface(s) and associated methods may be applied to other applications.

By implementing the dynamic interfaces according to embodiments of the present disclosure, users will be better equipped to access specific data and application functionality, and make more informed decision in real-time. The dynamic interfaces of the present disclosure avoid the problems associated with navigating through a plurality of applications and numerous menus to obtain customer information. As a result, users may more efficiently retrieve data and execute desired tasks.

A customer management application that enables analytical searches and facilitates contact management is provided. The various embodiments will now be described.

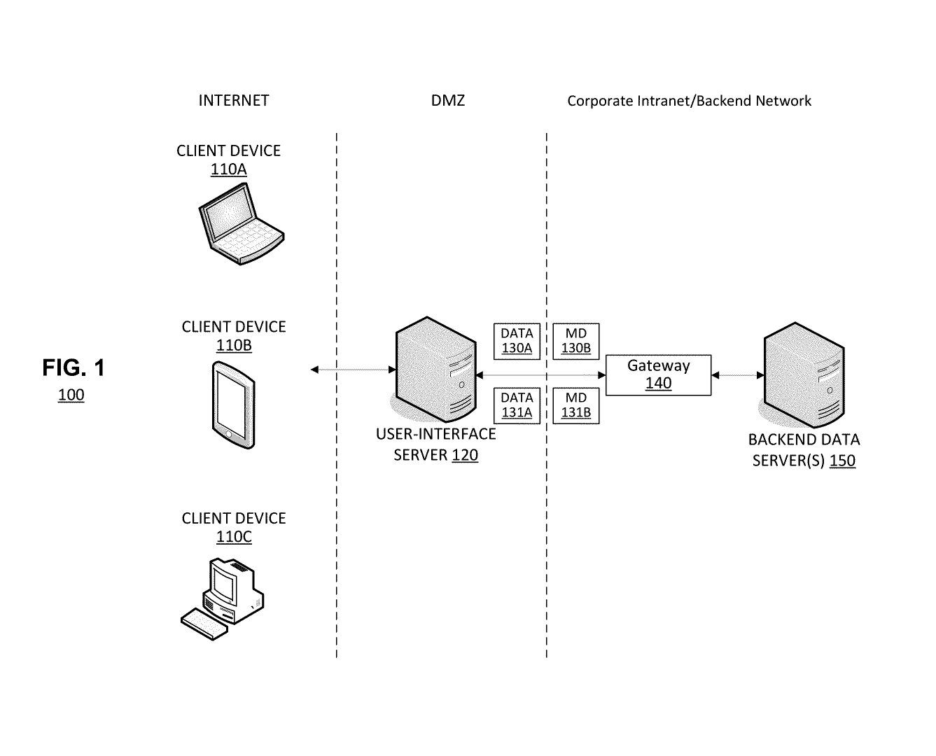

FIG. 1 is a system diagram depicting an architectural overview of a networked system 100 for generating analytical searches according to an example embodiment. The system 100 includes client devices 110A, 1108, 110C, UI (user interface) server 120, gateway 140, and backend data server(s) 150. Communications between components of the system 100 may utilize a variety of data transfer protocols, such as HTTP methods (e.g., get, post, put, and delete) or web socket, to query, interact, and manipulate data. In addition, the components of system 100 may be implemented using conventional and/or cloud networks.

As illustrated, the networked system 100 includes one or more client devices such as client devices 110A, 110B, 110C, being network accessible via an Internet connection, and connected to a UI server 120 in a network demilitarized zone (DMZ). Collectively, devices such as client devices 110A, 110B, 110C and UI server 120 may be referred to as a dynamic frontend system. Client devices 110A, 110B, 110C may include a variety of devices which may include, for example, a mobile device (e.g., mobile phone or a smartphone), a personal computer, a laptop, a tablet, or the like. Each of the client devices 110A, 110B, 110C is configured to transmit and receive data and metadata communications with the UI server 120. The data communications (e.g., 130 and 131) may be exchanged with backend data server(s) 150 via optional gateway 140.

The UI server 120 may be configured to transmit data 130A to an enterprise data system such as a backend server 150 in a corporate intranet/backend network. The optional gateway 140 may translate requests, such as data retrieval requests included in data 130A, to other proprietary protocols, such as remote function call (RFC). Alternatively, the functions of gateway 140 may be implemented at backend server(s) 150 such that it may directly receive requests. The backend server(s) 150 may be configured to process the request(s), retrieve data and/or perform data operations as an appropriate response to a request, and return a response for transmission back to the gateway 140. Again, the gateway 140 may be used to translate a proprietary protocol. The data response 131 may be transmitted from gateway 140 (which is located in the backend network) to the appropriate client device 110A, 110B, 110C via UI server 120.

UI server 120 may include a data handler adapted to retrieve data and/or metadata from the gateway 140 and/or backend server(s) 150. The metadata may include information about the type of the data (e.g., date, type of input field, read-only/editable, function, etc.) as well as information about the relevance of the data. Using the information gathered from backend server(s) 150, the UI server 120 may aggregate data from data server(s) 150. In addition, the UI server 120 may instruct a client device 110 to generate and render user interfaces in a dynamic manner.

Backend server(s) 150 may include a variety of data sources. Some example external data sources may include transactional information such as sales activities, quotations, and sales orders from CRM and ERP systems. In some instances, the UI server 120 and/or gateway 140 may aggregate data from multiple backend servers. Thus, aggregated data may be presented along one or more displays of a customer management application.

Within backend system 150 (or UI server 120 and/or gateway 140), a variety of data, such as master data (e.g., contact information, sales statistics, etc.) and transactional data, may be quickly aggregated without compromising backend or overall system performance. In some instances, various data may be represented using virtual data models (VDMs) to enable faster data aggregation. Here, a plurality of VDMs may be aggregated into fewer, or even a single VDM. In addition, the backend system 150 may be implemented by or coupled to an in-memory database.

In-memory databases are located within the main memory of a computer system or a coupled device, which provides the advantage of faster data access and faster program execution. In-memory databases also enable real-time operation on a computer or device, or on multiple computers or devices communicating through wired or network connections. An example of an in-memory database is the SAP® high-performance analytic appliance (HANA). However, the embodiments are not limited to any particular in-memory database technology.

When using server-side UI technologies (e.g., Perl, SAP-WebDynpro, SAPGui, etc.), a UI server 120 may generate the UI code at runtime. However, depending on the UI technology, some embodiments may implement the functions of the UI server 120 on the client-side. For example, functions of the UI server 120 may be implemented at the client device 110A, 1106, 110C on a browser using HTML5/javascript/css, or on a device using ObjectiveC. Thus, in some implementations, use of UI server 120 is optional.

Gateway 140 may be located between the UI server 140 and the backend server(s) 150 to intercept data communications, such as data 130, 131. The gateway 140 acts as a middle party with both client and server functionality to handle communications in both directions. The gateway 140 may perform server functions, such as responding to data requests from client devices 110A, 1106, 110C. Data responses may be included in data 131A. The gateway 140 also performs client functions, such as forwarding incoming data requests from the client device (110A, 1106, 110C) to the backend server(s) 150. The gateway 140 may forward a data request 120 to the backend server(s) 150, and receive a corresponding data response 131. The data response 131 may be relayed to the UI server 120 as data 131A and metadata 131B.

After receiving the data response 131 from the gateway 140 (and correspondingly, from the backend server(s) 150), the gateway 140 can append metadata 131B to received data 131. Once the data response 131A, 131B is generated by gateway 140, the data response 131A, 131B may be returned to the client device 110A, 1106, 110C by UI server 120. As shown, response data 131A and response metadata 131B may be communicated from the gateway 140 to the UI server 130, for communication to the appropriate client device 110A, 1106, 110C.

Data relating to a group of users, such as peer groups, may relate to interactions with a single or multiple backend server(s) 150. Example groups may designate similarly situated users, such as employees of particular business units, managers, occasional consumers, business customers, etc. In another example, groups may be based upon the role of the user (e.g., sales rep, payroll admin, etc.).

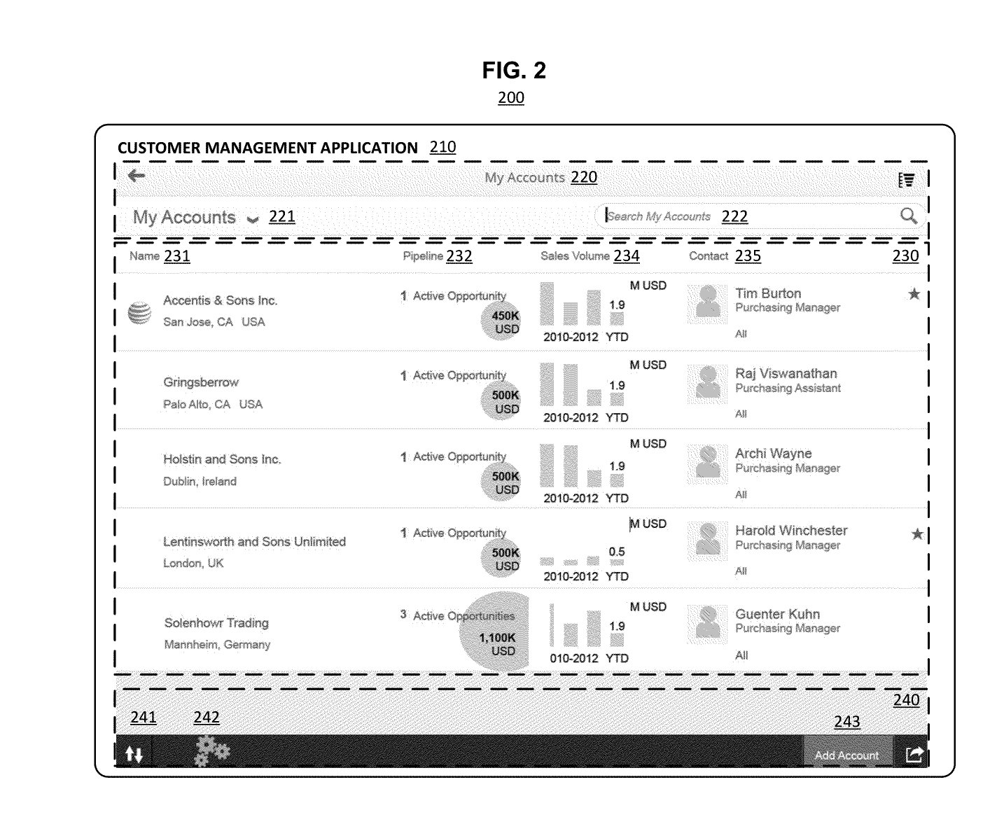

FIG. 2 illustrates a representative view of an electronic device having a customer management application 210 according to an example embodiment of the present invention. As shown in FIG. 2, the electronic device 200 includes a display, such as touchscreen interface, and customer management application 210 displayed thereon. The customer management application 210 may include an account selection section 220, account description section 230, and menu section 240.

Within the account selection section 220, a user may select one or more accounts to be displayed within the account description section 230. For example, a user may select one or more accounts via a dropdown menu 221, text search box 222, or the like. Account information may be stored locally at the electronic device 200 or at a remote backend system (e.g., element 150, as shown in FIG. 1). In some embodiments, select account information (e.g., account names) may be stored locally and more detailed account information (e.g., pipeline information, sales volumes, and contact information) may be stored at a remote backend system.

Selected accounts may be displayed within account description section 230. In addition to the account name 231, additional information also may be displayed. For example, pipeline field 232 may display one or more expected (or potential) opportunities for each selected customer account. Here, both the number expected opportunities and their respective values may be displayed. Also, expected opportunities may be displayed using text and/or graphical displays.

In sales volume section 234, past sales data for each selected account may be displayed. For example, past sales data may be graphically displayed. In some instances, the time period for past sales data may be varied, such as from months to quarters or years. In the example depicted in FIG. 2, past sales data is depicted using a bar chart, each bar representing a recent quarter. However, alternative graphical displays may be used.

In addition, the contact person for each account may be displayed within contact section 235. More detailed contact information such as a telephone number, facsimile number, mailing address, e-mail address, and the like may be displayed by selecting a contact name listed in contact section 235.

Although pipeline information 232, sales volume 234, and contact information 235 are displayed as examples of account information, the embodiments are not so limited. Accordingly, the customer management application may be configured to display additional account information depending on user needs. For example, appointments, telephone calls, tasks, price quotations, sales orders, and the like may be displayed.

Within account selection section 220 and/or account description section 230, the various accounts may be displayed may be displayed according to a calculated importance value (e.g., based on customer sales volume, expected sales volume, or combination thereof). In addition, a selected account may be highlighted or otherwise visually depicted to indicate selection by a user. Once an account is selected, more detailed information associated with the account may be displayed within description section 230.

Additionally, alert indicators such as a warning symbol may be used to identify upcoming events to a user. For example, an alert indicator may be used to identify an upcoming due date or an expiring price quote.

Menu section 240 may include sort module 241, settings module 242, and add account module 243. Using sort module 241, the selected accounts may be sorted by account name, pipeline value, recent sales volume, contact name, or other account related values.

Settings module 242 may include a preferences menu. The preferences menu may be invoked by selecting a settings button (e.g., right click or a double tap). The example settings module 242 may include display configuration and format settings, additional information, options to delete the one or more portions of the display, and other options to modify or control the display.

New customer accounts may be added by pressing and holding a finger or other object to the “add account” button 243. When the user presses and holds the “add account” button, the user may be prompted to enter information for the new account. For example, a window may be displayed to prompt the user to enter details for the added account. Information for newly added accounts may be stored locally and may also be stored at a backend server. The newly added account may be included to the account description section 230.

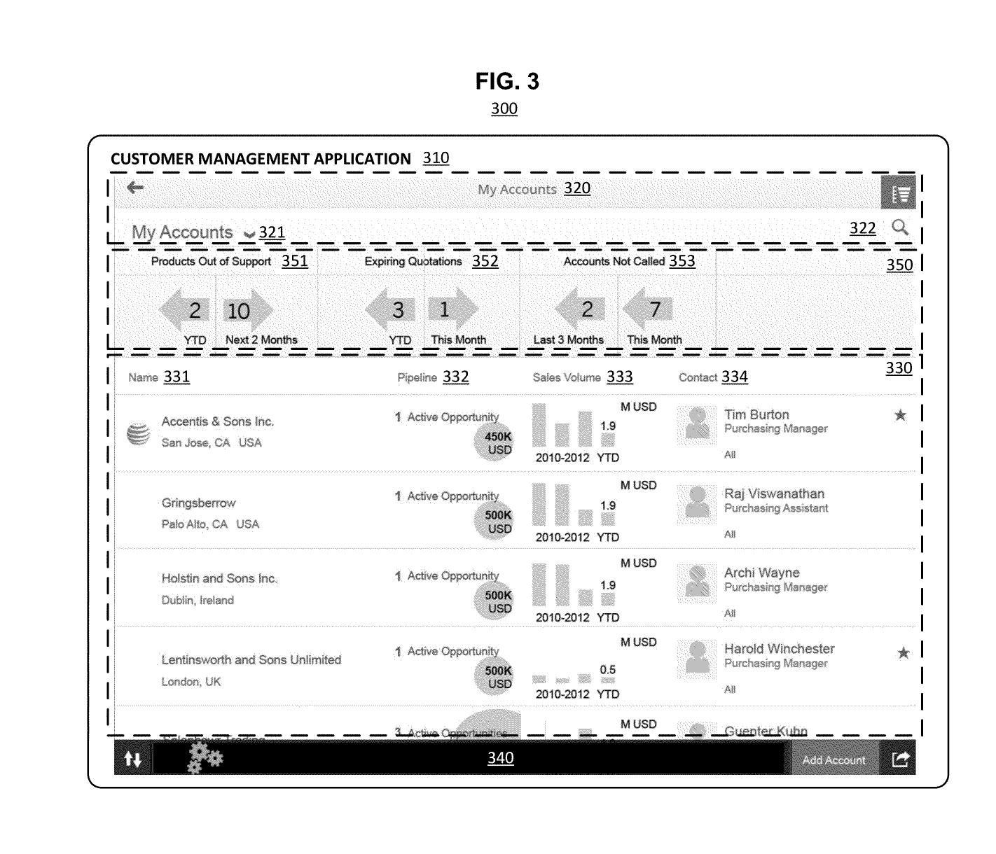

FIG. 3 illustrates a representative view of an electronic device having a customer management application 310 according to another example embodiment of the present invention. As shown in FIG. 3, the electronic device 300 includes a display, such as touchscreen interface, and customer management application 310 displayed thereon. The customer management application 310 may include an account selection section 320, account description section 330, menu section 340, and task menu 350.

Within the account selection section 320, a user may select one or more accounts to be displayed within the account description section 330. For example, a user may select one or more accounts via a dropdown menu 321, text search box 322, or the like.

Selected accounts may be displayed within account description section 330. In addition to the account name 331, additional information also may be displayed. For example, pipeline field 332 may display one or more expected (or potential) opportunities for each selected customer account. Both the number expected opportunities and their respective values may be textually and/or graphically displayed.

In sales volume section 334, past sales data for each selected account may be displayed. For example, past sales data may be graphically displayed. In the example depicted in FIG. 3, past sales data is depicted using a bar chart, each bar representing a recent quarter. In addition, the contact person for each account may be displayed within contact section 335.

Menu section 340 may include sort module 341, settings module 342, and add account module 343. Using sort module 341, the selected accounts may be sorted by account name, pipeline value, recent sales volume, contact name, or other account related values.

Settings module 342 may include a preferences menu. The preferences menu may be invoked by selecting a settings button. The example settings module 342 may include display configuration and format settings, additional information, options to delete the one or more portions of the display, and other options to modify or control the display.

New customer accounts may be added by selecting an “add account” button. When the user selects the “add account” button, the user may be prompted to enter information for the new account. Also, the newly added account may be included to the account description section 330.

As compared to the embodiments of FIG. 2, the example customer management application 310 may include task menu 350. Task menu 350 may be adapted identify upcoming events for a single or a plurality of customers. In the example depicted in FIG. 3, task menu 350 identifies products out of support 351, expiring quotes 352, and accounts not called 353. Each of task menus 351-353, may identify past and upcoming events. For example, products out of support 351 may identify products that are no longer supported as well as products that may not be supported in upcoming months. Similarly, expiring quotes 352 may identify quotes that have expired as well as quotes that are expected to expire in the coming months. In yet another example, accounts not called 353 may identify customers not contacted in past months as well as customers not contacted in the current month.

Although products out of support 351, expiring quotes 352, and accounts not called 353 are displayed as example task menus, the embodiments are not so limited. For example, the user may define one or custom filters to identify certain customers, as needed. Accordingly, the customer management application may be configured to display other task menus depending on user needs. In addition, task menus 351-353 and other custom filters may be configured to define the customers displayed within account description section 330. Here, the tasks and/or associated customers may be displayed according to a calculated importance value (e.g., based on customer sales volume, expected sales volume, or combination thereof).

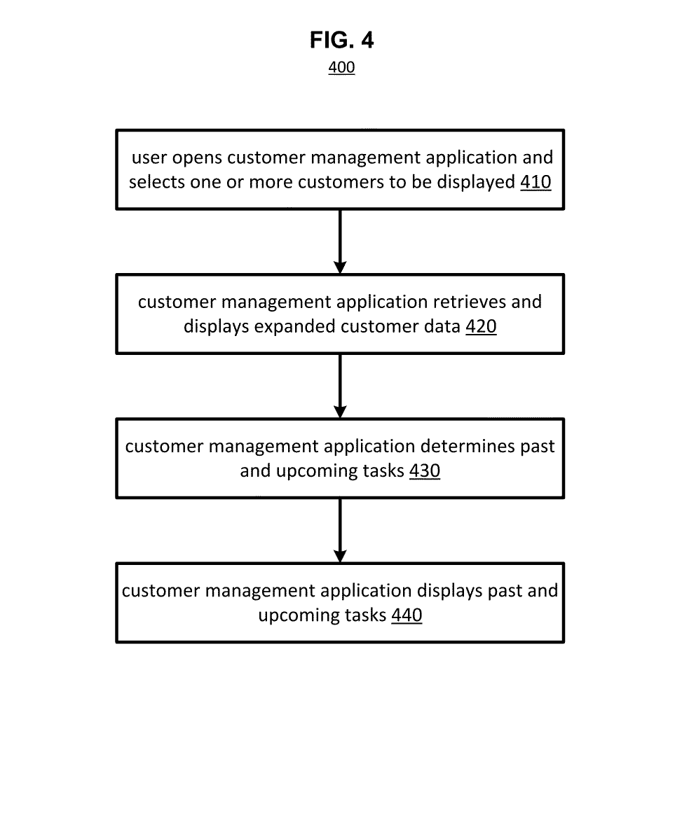

FIG. 4 illustrates a method for navigating the customer management application according to an example embodiment of the present invention.

At step 410, a user opens the customer management application and selects one or more customers to be displayed. As discussed above, a user may manipulate account selection section to select one or more customer accounts to be displayed within an account description section.

Initially, for example, customers displayed may include the last customers viewed by the user. In another example, the customers displayed may be determined by another application, such as e-mail. As desired, the user may add, remove, or modify the selected customers to be displayed. Optionally, the customer management application may be linked to another application such that customers may be added through the one or more other applications.

In some instances, the customer management application may require that a user provide a login name and login password to access the customer management application. The login name and login password may then be used to identify individual users associated with a customer management application.

At step 420, the customer management application retrieves and displays expanded customer data. Within account description section, expected (or potential) opportunities, past sales data, customer contact information, and/or additional data may be displayed.

Next, at 430 customer management application determines past and and/or upcoming tasks for a predetermined period of time (e.g., one month, six months, one year, or the like). As discussed in connection with FIG. 3, example tasks may include products out of support, expiring quotes, and accounts not called. Lastly, customer management application displays past and upcoming tasks at 440.

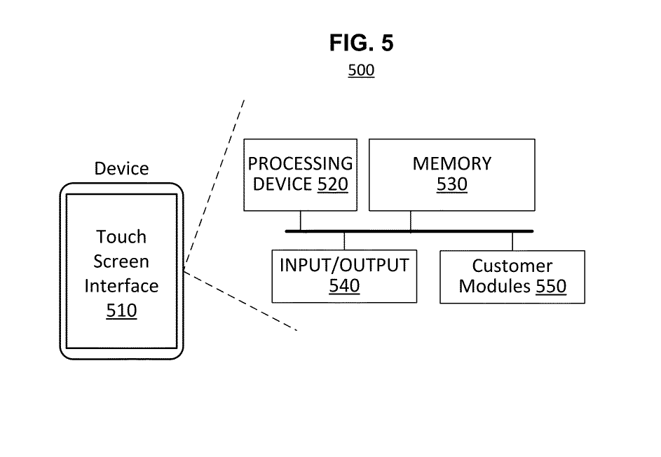

FIG. 5 illustrates a representative architecture of an electronic device according to an example embodiment of the present invention.

An electronic device 500 may include a touchscreen interface 510, processing device 520, memory 530, communications interface 540, and customer management module(s) 550. The touchscreen interface 510 may include a display, which may be a touchscreen, capable of displaying data to a user of the electronic device 500.

Although not shown, the touchscreen interface 510 may include a sensor that may be a capacitive touch detection sensor, configured to detect and track movement on the surface and/or in the vicinity of the display. The sensor may be coupled to a signal processing circuit that is configured to identify, locate, and/or track object movement based on the data obtained from sensor.

The electronic device 500 may contain a processing device 520, memory 530, and a communications device 540, all of which may be interconnected via a system bus. In addition, the electronic device 500 may include customer management module(s) 550 that generally implement the functionality of the customer management application. In various embodiments, the electronic device 500 may have an architecture with modular hardware and/or software systems that include additional and/or different systems communicating through one or more networks via communications device 540.

Communications device 540 may enable connectivity between the processing device 520 in the device 500 and other systems by encoding data to be sent from the processing device 520 to another system over a network and decoding data received from another system over the network for the processing device 520.

Memory 530 may include a computer readable medium storing application modules, which may include instructions associated with applications and modules of the electronic device 500. In an embodiment, memory 530 may contain different components for retrieving, presenting, changing, and saving data and may include computer readable media. Memory 530 may include a variety of memory devices, for example, Dynamic Random Access Memory (DRAM), Static RAM (SRAM), flash memory, cache memory, and other memory devices. Additionally, for example, memory 530 and processing device(s) 520 may be distributed across several different computers that collectively comprise a system. Memory 530 may be capable of storing user inputs and preferences as well as customized sequences.

Processing device 520 may perform computation and control functions of a system and comprises a suitable central processing unit (CPU). Processing device 520 may include a single integrated circuit, such as a microprocessing device, or may include any suitable number of integrated circuit devices and/or circuit boards working in cooperation to accomplish the functions of a processing device. Processing device 520 may execute computer programs, such as object-oriented computer programs, within memory 530.

Thus, systems and methods for implementing analytical searches and their smart use in account and contact management are provided. According to the embodiments, data originating from multiple data sources may be aggregated and displayed on a single display. Using the embodiments, an end user may quickly review the aggregated data, such as comprehensive data reflecting review of a client relationship. The embodiments may be adapted to interface with a variety of data sources including CRM and ERP systems.

The foregoing description has been presented for purposes of illustration and description. It is not exhaustive and does not limit embodiments of the invention to the precise forms disclosed. It will be apparent to those skilled in the art that various modifications and variations can be made in the analytical searches and their smart use in account and contact management of the present invention without departing from the spirit or scope of the invention. Thus, it is intended that the present invention cover the modifications and variations of this invention provided they come within the scope of the appended claims and their equivalents.

We claim:

1. A method for navigating a customer management application hosted on an electronic device, the method comprising:
displaying, by a processor, a plurality of customers and associated entries for each respective customer;
analyzing the plurality of customers to determine one or more tasks associated with the plurality of customers;
displaying, by the processor, the associated tasks;
upon detecting a user input, varying the plurality of customers and the associated tasks according to the user input,
wherein the associated entries include aggregated data originating from a plurality of backend data sources.

2. The method according to claim 1, further comprising calculating an importance value for each task.

3. The method according to claim 2, further comprising displaying the tasks according to their calculated importance value.

4. The method according to claim 1, wherein the aggregated data includes master and transactional data.

5. The method according to claim 1, wherein data is aggregated using an in-memory database.

6. The method according to claim 1, wherein the user input is detected by a touch screen.

7. A non-transitory computer readable storage medium storing one or more programs configured to be executed by a processor of an electronic device, the one or more programs comprising instructions for:
displaying, by a processor, a plurality of customers and associated entries for each respective customer;
analyzing the plurality of customers to determine one or more tasks associated with the plurality of customers;
displaying, by the processor, the associated tasks;
upon detecting a user input, varying the plurality of customers and the associated tasks according to the user input,
wherein the associated entries include aggregated data originating from a plurality of backend data sources.

8. The computer readable storage medium of claim 7, further comprising calculating an importance value for each task.

9. The computer readable storage medium of claim 8, further comprising displaying the tasks according to their calculated importance value.

10. The computer readable storage medium of claim 7, wherein the aggregated data includes master and transactional data.

11. The computer readable storage medium of claim 7, wherein data is aggregated using an in-memory database.

12. The computer readable storage medium of claim 7, wherein the user input is detected by a touch screen.

13. An electronic device comprising:
one or more processors; and
memory storing a plurality of integrated programs for execution by the one or more processors, one of the plurality of integrated programs including:
displaying, by a processor, a plurality of customers and associated entries for each respective customer;
analyzing the plurality of customers to determine one or more tasks associated with the plurality of customers;
displaying, by the processor, the associated tasks;
upon detecting a user input, varying the plurality of customers and the associated tasks according to the user input,
wherein the associated entries include aggregated data originating from a plurality of backend data sources.

14. The electronic device according to claim 13, further comprising calculating an importance value for each task.

15. The electronic device according to claim 14, further comprising displaying the tasks according to their calculated importance value.

16. The electronic device according to claim 13, wherein the aggregated data includes master and transactional data.

17. The electronic device according to claim 13, wherein data is aggregated using an in-memory database.

18. The electronic device according to claim 13, wherein the user input is detected by a touch screen.
